(19) United States
(12) Patent Application Publication
(10) Pub. No.: US 2016/0266162 A1
(43) Pub. Date: Sep. 15, 2016

(54) FULLY-AUTOMATIC PIPETTING INSTRUMENT AND USE THEREOF

(71) Applicant: DEGREE OF FREEDOM SCIENTIFIC MACHINE CO., LTD., Beijing (CN)

(72) Inventors: Dan LIU, Beijing (CN); Haifeng ZHAO, Beijing (CN)

(21) Appl. No.: 15/034,373

(22) PCT Filed: May 11, 2014
(86) PCT No.: PCT/CN2014/090402

§ 371 Date: May 4, 2016

(30) Foreign Application Priority Data
Nov. 6, 2013 (CN) 201310544587.8
Nov. 6, 2013 (CN) 201310544596.7
Mar. 20, 2014 (CN) 201410104387.5

(51) Int. Cl. G01N 35/10

(52) U.S. Cl. CPC G01N 35/1065; G01N 35/1083; G01N 2035/1076; G01N 2035/103

(57) ABSTRACT

The present invention provides a pipetting work station comprising a pipetting mechanism bracket and a plurality of pipetting mechanisms; wherein, the pipetting mechanism comprises a mobile seat, a mobile rod movably mounted on the mobile seat; a mobile rod drive mechanism; a gear capable of turning around the vertical direction; a linear rail fastening seat; and a pipette disposed at the lower end of the mobile rod. The present invention further provides the abovementioned pipetting mechanism. The present invention further provides usage of the pipetting work station in such aspects as liquid sample dosing and liquid transferring. The pipetting mechanism used in the pipetting work station provided by the present invention can independently make vertical or horizontal movements, and does not require or reduces lubricating services, which accordingly avoid contamination.

The present application claims priority of the Chinese patent application numbered 201310544596.7 entitled Pipetting Mechanism for Fully Automatic Pipetting Instrument and the Use Thereof, filed on Nov. 6, 2013, and the Chinese patent application numbered 201410104387.5 entitled Fully Automatic Pipetting Instrument and the Use Thereof, filed on Mar. 20, 2014, The disclosure of these applications is incorporated by reference in its entirety.

### TECHNICAL FIELD

The present application relates to an automatic liquid handling apparatus. Specifically, the present application relates to a fully automatic pipetting instrument and a pipetting mechanism equipped therein, and usage of the instrument in liquid dosing, pipetting or the like.

### BACKGROUND OF THE INVENTION

With rapid development of technologies in the area of life science, research works in biological laboratories are faced with more complicated objects for research and increasing number of samples, consequently, the traditional manual instruments are no longer able to produce high effectivity, precision and safety as required in the process of high through-put sample handling; while, to automate part or the total of the procedure of performing an experiment is now becoming an inevitable trend.

A fully automatic liquid handling work station refers to automatic operation platform in biological and medical laboratories that is sophisticatedly incorporated automatic operation and liquid handling, and is able to perform such operations as automatic sample dosing, reagent dispensing, ultra-micro liquid pipetting, vibration and incubation relating to liquid handling. It can be widely applied in areas such as purification of nucleic acids, sequencing genetic proteins, rapid screening of clone, well cultivation and manufacturing of biological chips and samples.

A pipetting mechanism is one of the key mechanisms adopted in a fully automatic liquid handling work station and is provided for transportation, extraction and transferring of liquid between standard liquid containers. As is used in the modern fully automatic liquid handling work station, the most common standard liquid containers are, for example, 8-well plates or 96-well plates. Wherein, the standard liquid container such as a 96-well plate has the minimum spacing between neighbouring wells of 9 mm, with a volume of about 0.5 ml, and 8 wells in each row. Accordingly, the automatic liquid handling work station, particularly the pipetting mechanism, is required to be able to do concurrent or discrete pipetting actions of multiple, for example eight, transfer pipettes with high precision and repeatability in a very confined space.

The automatic liquid handling work stations and the pipetting mechanisms in the prior art suffer from such shortcomings as mechanisms undergo heavy wear and have loud noise, operational movements are not done smoothly, requires very high precision in making sliding slots of the mobile seat, adjustment job during the process of assembly is quite complicated and heavy-loaded; besides, the daily operation and maintenance are cumbersome, and the inside of the instrument is prone to be contaminated and eroded.

### SUMMARY OF THE INVENTION

The present application provides a novel fully automatic work station that overcomes problems of heavy mechanism wear, complicated assembly and adjustment, and not smooth operation of the entire mechanism suffered by the pipetting mechanisms in the prior art, and also provides an inner setting that is easy to maintain and not prone to cause contamination.

The present invention provides a pipetting work station that comprises:

(a) a bracket for pipetting mechanisms;

(b) a plurality of pipetting mechanisms; wherein the pipetting mechanism comprises:

a mobile seat;

a mobile rod that is movably mounted on the mobile seat; wherein the mobile rod can make movements against the mobile seat in the vertical direction;

a mobile rod drive mechanism comprising a lead screw and a lead screw drive mechanism that are disposed parallel to the mobile rod; the lead screw is securely connected with the mobile rod via a drive connecter; a gear and a gear drive mechanism that are mounted on the mobile seat; the gear can turn around the vertical direction;

a linear rail fastening seat fastened onto the mobile seat; and a pipette disposed at the lower end of the mobile rod;

(c) a rack that is horizontally disposed and forms a gear pair with the gear of the pipetting mechanism; when the gear turns, the mobile seat is driven to make horizontal movement along the rack; and a linear rail that is horizontally disposed and is parallel to the rack;

(d) a slider of the linear rail is connected and fastened with the linear rail fastening seat of the pipetting mechanism, thereby the mobile seat can make horizontal movements along a track of the linear rail with the slider of the linear rail.

In the pipetting mechanism of the abovementioned pipetting work station, the linear rail fastening seat can be connected and fastened the slider of the linear rail. The linear rail can be disposed horizontally and be parallel to the rack. The slider of the linear rail is connected and fastened with the linear rail fastening seat, thereby the linear rail fastening seat and the mobile seat, which is connected and fastened with the linear rail fastening seat, can make horizontal movements with the slider of the linear rail along the track of a sliding catheter.

In one aspect of the present invention, the gear and the rack of the pipetting work station, the linear rail fastening seat and the linear rail are so positioned that allows driving the mobile seat fastened with the slider of the linear rail to make horizontal movements along the rack and the sliding track of the linear rail when the gear turns. For example, the gear and the linear rail fastening seat are arranged on the same side of the frame, and the corresponding rack and the linear rail are arranged parallel with one situating above the other one.

In one aspect of the present invention, the linear rail fastening seat has a quadrangular surface that is same as or similar to the surface of the slider of the linear rail in terms of shape and size. For example, the height of the linear rail fastening seat H1 is greater than 25 mm, preferably greater than 30 mm. The linear rail that can be compatible or used with the linear rail fastening seat is a linear rail with a slider width W greater than 25 mm, preferably greater than 30 mm.

In one aspect of the present invention, the linear rail fastening seat in the pipetting mechanism is connected with the mobile seat via a linear rail fastener. The linear rail fastener can be cast as an integral part of the mobile seat or can be fastened onto the mobile seat through screws or the like. The linear rail fastener is provided for fastening the two linear rail fastening seats. Typically, the linear rail fastener has a width that is same as or similar to the width of the linear rail fastening seat (which refers to the length in the horizontal direction) and a height greater than twice of that of the linear rail fastening seat (which refers to the length in the vertical direction). For example, the height of the linear rail fastener H2 is greater than or equal to 50 mm, preferably greater than or equal to 60 mm.

In one aspect of the present invention, the mobile seat of the pipetting mechanism has a quadrangular frame, whose four sides make discretely the upper beam, the lower beam and two side frames.

In one aspect of the present invention, the mobile rod in the pipetting mechanism of the pipetting work station is movably mounted at one side frame of the mobile seat.

In one aspect of the present invention, the side frame for mounting the mobile rod in the pipetting mechanism of the pipetting work station has a hallow groove which opens inward to the mobile seat; the mobile rod is movably disposed in the hallow groove, while part of the mobile rod situates outside the hallow groove, that is, part of the mobile rod sticks out beyond the inner surface of the left side frame. The protruding portion of the mobile rod can be securely connected with the drive connecter of the mobile rod drive mechanism.

In one aspect of the present invention, the mobile rod in the pipetting mechanism of the pipetting work station is movably mounted on the side frame of the mobile seat by means of a mobile rod sleeve mounted on the side frame. Wherein, the mobile rod sleeve is securely connected with the side frame, and the mobile rod can move within the mobile rod sleeve.

In one aspect of the present invention, the mobile rod sleeve in the pipetting mechanism of the pipetting work station is a sleeve made of a polymer material. For example, the Iglidur® series of products provided by Igus, such as Iglidur® G, Iglidur® W300, Iglidur® J, Iglidur® X and Iglidur® M250. Since parts made of the abovementioned polymer materials are lubricant-free (self-lubricating) and distinguish themselves through their good resistance against acid and alkane and exwellent vibration dampening, they do not need use of seal or oil scraper rings, so installment and replacement of these parts become quite easy. Preferably, the mobile rod sleeve in the pipetting mechanism provided by the present invention is not a part made of a metallic material.

In one aspect of the present invention, the mobile rod in the pipetting mechanism of the pipetting work station is a hollow duct. The hollow duct can be used to house layout of wires or pipetting catheters.

In one aspect of the present invention, the lead screw drive mechanism in the pipetting mechanism of the pipetting work station is a drive motor for the lead screw. The lead screw is driven by the drive motor. Preferably, the drive motor is a server motor.

In one aspect of the present invention, the lead screw is securely connected with the mobile rod through a nut and a drive connector. For example, the nuts are threaded on the lead screw, and one end of the drive connectors is connected with the mobile rod, while the other end thereof is fastened at the outer side of the nut. Preferably, the nut is made of a polymer material. Preferably, the nut used in the pipetting mechanism provided by the present invention is not made of a metallic material.

In one aspect of the present invention, the pipette body used in the pipetting mechanism of the pipetting work station comprises a stopper, a pipetting holder, a catheter connected below the pipetting holder, and the catheter can be connected with a replaceable pipetting tip. In another aspect of the present invention, a detachable sleeve is mounted on the catheter in the pipetting mechanism. In another aspect of the present invention, the pipetting tip is equipped with a liquid level sensor.

In one aspect of the present invention, the pipetting work station further comprises racks that are horizontally disposed and form gear pairs with the gears; when the gears turn, the mobile seats are driven to move along the racks in the horizontal direction.

In one aspect of the present invention, the pipetting work station further comprises linear rails that are horizontally disposed and are parallel to the racks. The sliders on the linear rails are connected and fastened with the linear rail fastening seats, so that the mobile seats can make horizontal movements along the tracks of the linear rails with the sliders of the linear rails. In one aspect of the present invention, the mobile seats are connected and fastened with the sliders of the linear rails via the linear rail fastening seats (which can further comprise linear rail fastening positions).

In one aspect of the present invention, the gears and the linear rail fastening seats are so positioned that allows the mobile seats to be driven to make horizontal movements along the direction of the racks and sliders of the linear rail at the time when the gears turn. The mobile seat is connected and fastened with the sliders of the linear rails via the linear rail fastening seats (which can further comprise linear rail fastening positions). For example, the gears and the linear rail fastening seats are mounted on the same side of one of the side frames, whilst the corresponding rack and linear rail are arranged parallel with one situating above the other one.

In one aspect of the present invention, the pipette body in the pipetting mechanism comprises a stopper, a pipetting holder, a catheter connected below the pipetting holder, and the catheter can be connected with a replaceable pipetting tip. In another aspect of the present invention, a detachable sleeve is mounted on the catheter in the pipetting mechanism. In another aspect of the present invention, the pipetting tip is equipped with a liquid level sensor. The liquid level sensor can be disposed below the pipetting holder.

In one aspect of the present invention, the pipetting work station comprises a plurality of (e.g., four or eight) of the abovementioned pipetting mechanisms, wherein two or more of the plurality of the pipetting mechanisms are arranged side by side; the mobile rods of the two or more of the plurality of the pipetting mechanisms that are arranged side by side lay out on the same line, and the gears of these two or more of the plurality of the pipetting mechanisms that are arranged side by side form gear pairs with the same rack. In another aspect of the present invention, the linear rail fastening seats of the mobile seats of the two pipetting mechanisms in the two or more pipetting mechanisms that are arranged side by side are connected with two sliders of the same linear rail. For example, the two mobile seats in the plurality of the pipetting mechanisms that are arranged side by side can be discretely connected with the two sliders of the same linear rail by means of discretely fastening the linear rail fastening seats of the two neighbouring mobile seats either on the upper part or the lower part of the linear rail fastener of the mobile seats. The gear and the rack, the linear rail fastening seat and the linear rail are so positioned that allows driving the mobile seat, which is fastened to the linear rail, to make horizontal movements along the direction of rack and the linear rail at the time when the gears turn.

In one aspect of the present invention, the pipetting work station comprises four or eight pipetting mechanisms. In a pipetting work station comprising eight pipetting mechanisms, the eight pipetting mechanisms are arranged into two parallel groups, wherein four pipetting mechanisms in each group are arranged side by side, and the gears of the four pipetting mechanisms in each group form gear pairs with the same piece of rack. In another aspect of the present invention, the linear rail fastening seats of the mobile seats in two of the four pipetting mechanisms in each group are discretely connected with the two sliders of the same linear rail. For example, the two mobile seats in the four pipetting mechanisms that are arranged side by side in each group can be discretely connected with the two sliders of the same linear rail through fastening discretely the linear rail fastening seats of the two neighbouring mobile seats on either the upper part or the lower part of the linear rail fastener of the mobile seat. The gears and the racks, the linear rail fastening seats and the linear rails are so positioned that allows driving the mobile seats, which is fastened to the linear rails, to make horizontal movements along the direction of rack and the linear rails at the time when the gears turn. In the pipetting work station provided by the present invention, the mobile rods of the four pipetting mechanisms in each group lay out on the same line and are arranged staggered with the four pipetting mechanism in the other group, so that the pipetting tips of the eight pipetting mechanisms can lay out on the same line.

In one aspect of the present invention, the pipetting work station further comprises other detection means or containers, for example, an injection pump, a heating panel, an oscillator, an photometer, a PCR instrument, a gripper mechanism and containers for placing a sample or reagent such as Eppendorf, a centrifuge tube, a PCR microplate, a deep well plate, a micro flow filter, a holder or the like.

In one aspect of the present invention, a pipetting mechanism as stated above is further provided. In one aspect of the present invention, the pipetting mechanism comprises: a mobile seat; a mobile rod movably mounted on the mobile seat, and the mobile rod can make movements against the mobile seat in the vertical direction; a mobile rod drive mechanism comprising a lead screw arranged parallel to the mobile rod and a lead screw drive mechanism, wherein the lead screw is securely connected with the mobile rod via a drive connector; a gear and a gear drive mechanism that are mounted on a frame of the mobile seat (e.g., the inner side or the outer side of the frame, preferably the outer side), wherein the gear can turn around the vertical direction; a linear rail fastening seat fastened on a frame of the mobile seat (e.g., the inner side or the outer side of the frame, preferably the outer side); and a pipetting tip disposed at the lower end of the mobile rod.

In one aspect of the present invention, a multichannel pipetting apparatus using the pipetting mechanism is further provided. The multichannel pipetting apparatus is equipped with two, four or eight of the pipetting mechanisms.

The pipetting mechanism, apparatus and instrument provided by the present invention allows each pipetting mechanism to totally independently make longitudinal or horizontal movements, the overall layout of their structure is more reasonable, and the space for accommodating movement is much clearer, while difficulty and complexity experienced in adjustment job during the process of assembly are greatly reduced. Additionally, a self-lubricating maintenance-free polymer material is employed to prepare the sleeve that fastens the mobile rod and accommodates sliding movement of the mobile rod inside so the hollow square tubes can make smooth and gentle movement quietly within the sleeve made of a polymer material; this also makes it unnecessary to lubricate the sleeve or reduces lubricating service to the sleeve, which accordingly avoid the potential of contamination arising from oil lubricant used to the pipetting operation. Furthermore, in the screw pair employed in the pipetting mechanism of the present invention for enabling the pipetting tip to make vertical movement, the lead screw is driven by a server motor; and this overcomes shortcomings of huge mechanical vibration and instability suffered in the prior art. Besides, a clearance elimination structure is employed in the nut, which can eliminate most mechanical gap in the movement of the nut and lead screw and accordingly can further allow transmission with better precision, thereby enabling the pipetting tips to perform more sophisticated operation of pipetting. Wherein, the screw nut also can be made of a polymer material, accordingly, the mechanism for drive the pipetting tips to make vertical movements needs no or less lubricating service, which accordingly avoids the potential of condemnation arising from oil lubricant to pipetting operation.

### BRIEF DESCRIPTION OF THE DRAWINGS

FIG. 1 illustrates part of the layout inside the pipetting work station provided in a preferred embodiment of the present invention.

FIG. 2 illustrates a 3D view of the pipetting mechanism in the pipetting work station provided in a preferred embodiment of the present invention.

FIG. 3 illustrates a sectional view of the pipetting mechanism in the pipetting work station provided in a preferred embodiment of the present invention.

FIG. 4 illustrates part of installation diagram of the pipetting mechanism in the pipetting work station provided in a preferred embodiment of the present invention.

FIG. 5 illustrates a 3D view of part of the pipetting work station from another angle provided in a preferred embodiment of the present invention.

### REFERENCE SIGNS FOR THE APPENDED DRAWINGS

1 Mobile seat
2 Square tube sleeve
201 projection on the square tube sleeve
3 Lead screw coupling
4 Lead screw
6 Nut
7 Hollow square rod
8 Gear coupler
9 Holder backplane
11 Motor seat
12 Gear drive motor
13 Mobile rod drive motor
14 Gear bearing
15 Gear shaft
16 Gear
17 Drive connecter
18 Ceiling
19 Floor
21 Upper beam
22 Lower beam
23 Left frame
231 Groove on the left frame
24 Right frame
25 liquid level sensor
26 Catheter
27 Pipetting holder
28 Detachable sleeve
30 Pipetting tip
31 Stopper
33 Wiring duct connector
34 Linear rail fastening seat
35 Linear rail fastener
36 Circuit board housing
40 Linear rail
41 Linear rail sliding track
42 Linear rail slider
43 Rack

### DETAILED DESCRIPTION OF THE INVENTION

Here below, the present invention is to be described at length in conjunction with the appended drawings for a better understanding and description of the present invention.

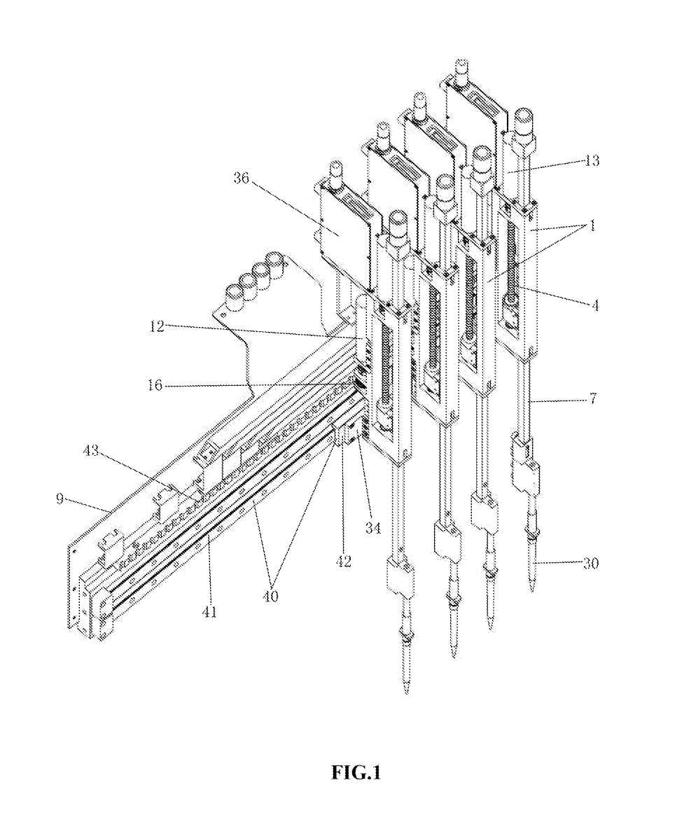

FIG. 1 illustrates part of the layout inside the pipetting work station provided in a preferred embodiment of the present invention.

The pipetting work station provided by the present invention normally comprises eight pipetting mechanisms 38 employed for liquid dosing and pipetting. The eight pipetting mechanisms are arranged into two parallel groups, wherein four pipetting mechanisms in each group are arranged side by side. FIG. 1 shows the diagram of part of means inside the pipetting work station provided by the present invention, which comprises a means that comprising a group of the four pipetting mechanisms. The pipetting mechanism comprises a mobile seat 1 having a quadrangular frame. The pipetting mechanism further comprises a mobile rod 7 that can be movably mounted vertically on one side of the frame of the mobile seat, and a pipetting tip 30 disposed at the lower end of the mobile rod. The mobile rod can make upward and downward movements against the mobile seat within the frame in the vertical direction. The drive mechanism for drive mobile rod to make upward and downward movements against the mobile seat comprises a lead screw 4 that is mounted onto the mobile set and is parallel to the mobile rod. The pipette is a mechanism for performing functions of liquid sensing, transferring and drawing in liquid; the pipette can make upward and downward movements with upward and downward movements of the mobile rod and allow handling of liquid sample in a container placed below the pipette.

The pipetting mechanism is further equipped with a gear 16 that is mounted outside the frame of the mobile seat and can turn around the vertical direction; the gear can form a gear pair with a rack 43 disposed horizontally, and the mobile seat can be driven to make movements along the rack when the gear turns. The pipetting mechanism further comprises a linear rail fastening seat, which is fastened onto the mobile seat, for connecting and fastening with a slider 42 of the linear rail, thereby the mobile seat can slide along a linear rail, which is horizontally disposed, to make horizontal movements. The gear 16 and rack 43, and the linear rail fastening seat 34 and the linear rail 40 are so positioned that allows driving the mobile seat, which is fastened to the linear rail, to make horizontal movements along the direction of rack and sliding track of the linear rail at the time when the gear 16 turns.

In the pipetting work station provided by the present invention, the mobile rods of the four pipetting mechanisms in each group lay out on the same line and are arranged in a staggered manner with the mobile rods of the four pipetting mechanisms in the other group, so that the pipetting tips of the eight pipetting mechanisms can lay out on the same line.

As shown in the preferred embodiment, the gears of the four pipetting mechanisms in each group of the pipetting work station form a gear pair with the same piece of rack, wherein the linear rail fastening seats 34 on two neighboring mobile seats are discretely connected with the two sliders of the same linear rail, so that the four pipetting mechanisms in each group are connected with two linear rails. The one rack and the two linear rails are arranged parallel with one situating above the other.

The pipetting work station provided by the present invention can further comprise a housing (not shown) and a bracket for holding the aforesaid pipetting mechanisms. The bracket can comprise posts, a transverse beam and a backplane for holding and/or mounting the pipetting mechanisms. As shown in FIG. 1, the one rack and the two linear rails arranged parallel with one situating above the other, and are securely fastened onto the backplane 9. The backplane 9 can be securely fastened on a side wall of the housing or onto the transverse beam mounted inside the housing.

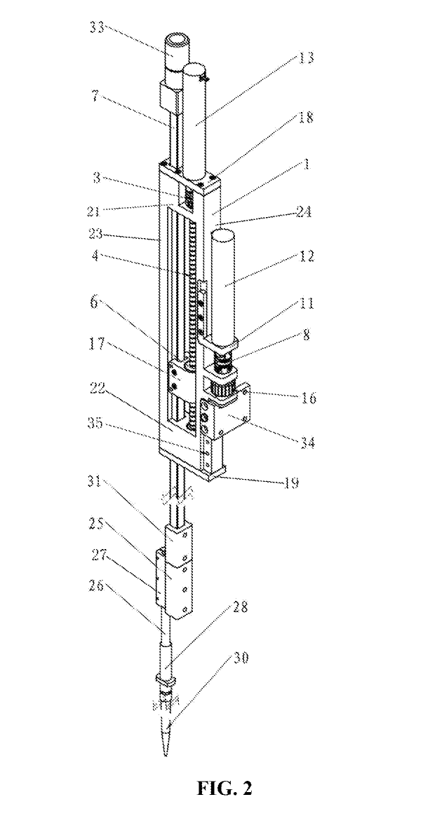

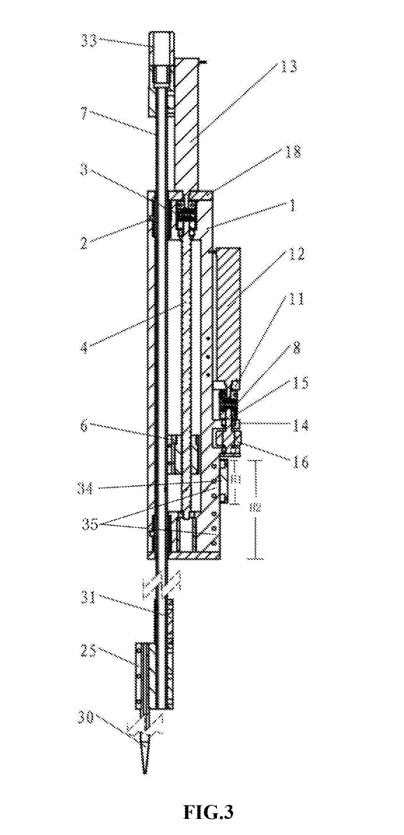

FIG. 2 shows a 3D view of the pipetting mechanism in the pipetting work station provided in a preferred embodiment of the present invention. FIG. 3 illustrates a sectional view of the pipetting mechanism in the pipetting work station provided in a preferred embodiment of the present invention.

As shown in FIG. 2 and FIG. 3, the pipetting mechanism has a mobile seat that comprises a quadrangular frame; the pipetting mechanism further comprises a mobile rod that is movably mounted in a vertical direction onto one side frame of the mobile seat (frame 23 as shown) and pipetting tip disposed at the lower end of the mobile rod. The mobile rod can make upward and downward movements in the vertical direction against the mobile seat within the frame, and the pipetting tip is provided for performing functions of sensing, transferring and drawing in liquid, and it can make upward and downward movements along with upward and downward movements of the mobile rod, which accordingly allows handling of liquid sample in a container placed below the pipetting tip. The pipetting mechanism further comprises a drive mechanism for drive the mobile rod to make upward and downward movements against the mobile seat, and it comprises a lead screw and a drive motor for the lead screw that are mounted onto the mobile seat and are parallel to the mobile rod; the lead screw is securely connected with the mobile rod via a drive connector. The pipetting mechanism further comprises a gear and a drive mechanism for the gear that are mounted at the outer side of the frame of the mobile seat, and the gear is capable of turning along the vertical direction; the gear can form a gear pair with the horizontally disposed rack, which accordingly drives the mobile seat to make horizontal movements when the gear turns; the pipetting mechanism further comprises a linear rail fastening seat, which is fastened onto the mobile seat, for connecting and fastening with the slider of the linear rail, thereby the mobile seat can slide along the horizontally disposed linear rail to make horizontal movements.

In the pipetting mechanism provided in the preferred embodiment as shown in FIG. 2, the mobile seat is a rectangular element with a quadrangular frame whose four sides are respectively the upper beam 21, the lower beam 22, the left side frame 23 and the right side frame 24. The mobile seat normally can be made of a metallic material such as aluminum or stainless steel that is capable of reducing equipment weight and lessening liquid traction. The frame has a thickness to a certain extent that can provides support to the motor and means for accommodating devices such as circuit board housing for a controlling motor, and also can accommodate and hold the mobile rod. For example, the frame can have a thickness similar to that of the width of the motor (e.g., the diameter of a cylindrical motor or the width of a rectangular motor) or have a thickness greater than the width of the mobile rod (e.g., the diameter of a cylindrical mobile rod or the width of a rectangular mobile rod). In one aspect of the present invention, the frame has a thickness greater than 0.5 cm. The use of a frame has the advantage of reducing component weight. In other embodiments, the mobile seat alternatively can be a rectangular element with no hollow part. In this case, parts of the four sides are equivalent to the abovementioned quadrangular frame, namely, ‘the upper beam, the lower beam, the left side frame and the right side frame’.

In the preferred embodiment as shown, the left side frame 23 is provided for mounting the mobile rod 7 that makes upward and downward movements against the mobile seat within the frame. In the preferred embodiment as shown, the left side frame 23 is a hollow structure, and the mobile rod 7 is movably mounted in the left side frame. In the preferred embodiment as shown, the left side frame 23 comprises a groove which opens inward to the mobile seat (i.e., open towards the right side frame); the mobile rod is movably mounted in the groove, whilst part of the mobile rod sticks out beyond the groove, namely, beyond the inner surface of the left side frame. The protruding part of the mobile rod can be employed to establish a secure connection with the drive mechanism that is provided for drive the mobile rod to make upward and downward movements.

As shown in FIG. 2 and FIG. 3, the drive mechanism for drive the mobile rod to make upward and downward movements against the mobile seat within the left side frame comprises a lead screw 4 and a drive motor 13 for the lead screw that are mounted onto the mobile seat and are situated parallel to the mobile rod. Preferably, the drive motor 13 is a server motor. Connection and conveying between the drive motor 13 and the lead screw 4 is done via a coupler 3. The two ends of the lead screw are restricted between the upper beam and the lower beam of the mobile seat through a bearing. The drive motor 13 can be disposed above the lead screw. In the preferred embodiment as shown, the upper beam of the mobile seat has a groove in which a coupler 3 can be accommodated; in addition, a ceiling panel 18 is disposed above the upper beam, and the drive motor is perpendicularly mounted above the ceiling panel 18. The ceiling panel can have a length and a width same as or similar to those of the upper beam. The ceiling panel alternatively can have a length greater than that of the upper beam, and can be provided for accommodation and arrangement of means such as circuit board housing for a controlling motor or the like (e.g., the circuit board housing 29 shown in FIG. 1). Such a design allows saving significant inner space of an automatic pipetting instrument using the pipetting mechanism provided by the present invention, which accordingly facilitates layout of wires and pipetting catheters.

The lead screw 4 is securely connected with the mobile rod 7 via a nut 6 and a drive connector 17. Wherein, the nut 6 is threaded onto the lead screw; one end of the drive connector 17 is securely connected with the mobile rod by means of screws or the like, while the other end thereof can be secured at the outer side of the nut 6 through threading. When the lead screw starts turning when it is driven by the drive motor 13, the drive connector 17 can make upward and downward movements within the space between the upper beam and the lower beam of the mobile seat, thereby drive the mobile rod to make upward and downward movements. In one aspect of the present invention, a gap clearance structure can be adopted in the nut, which can eliminate most mechanical gap arising from movements between the nut and the lead screw. In one aspect of the present invention, the nut is made of a polymer material, for example, the Iglidur® series of products provided by Igus, such as Iglidur® G, Iglidur® W300, Iglidur® J, Iglidur® X and Iglidur® M250. Since parts made of the abovementioned polymer materials are lubricant-free (self-lubricating) and distinguish themselves through their good resistance against acid and alkane, and exwellent vibration dampening, they do not need use of seal or oil scraper rings, so installment and replacement of these parts are quite easy.

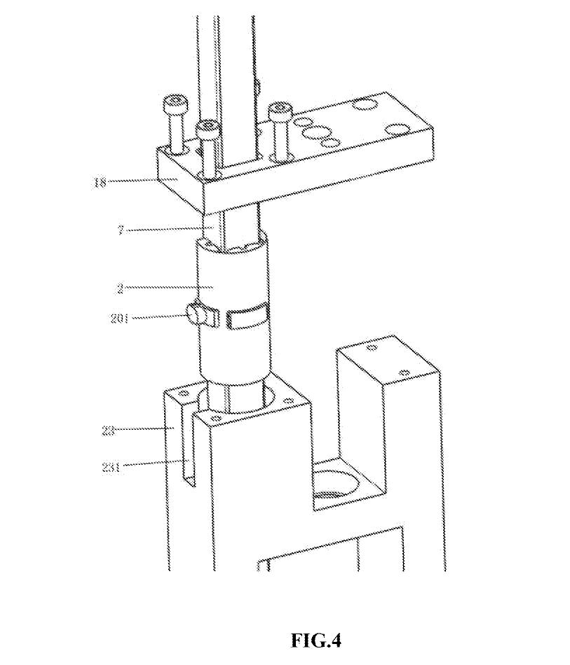

The mobile rod of the pipetting mechanism provided by the present invention as shown, which is movable in the vertical direction (namely the direction parallel to the frame and the vertical direction refers to the direction of gravity in the technical field), is fastened onto the mobile seat. Preferably, the mobile rod is movably fastened in a frame of the mobile seat. For example, the mobile rod can be mounted in the frame of the mobile seat through mobile rod sleeves mounted onto the upper end and the lower end of the frame, wherein the mobile rod sleeves are securely connected with the frame, and the mobile rod can move within the mobile rod sleeve. In the embodiment as shown, the mobile rod is the square rod 7, which is movably fastened with the left frame 23 at the upper end and the lower end of the mobile seat through square rod sleeves 2. FIG. 4 illustrates how the square rod 7, the square rod sleeves 2 and the left frame 23 are connected. As shown in FIG. 4, the square rod sleeve is secured inside (e.g. through fitting of an projection 201 on the square rod sleeve into the groove 231 disposed at the left frame) one end of the left frame 23 (e.g., the upper end as shown, while the lower end also has the same structure), thereby the square rod 7 can slideably fit in the square rod sleeve 2. In one aspect of the present invention, the square rod sleeve is made of a self-lubricating polymer material, for example, the Iglidur® series of products provided by Igus, such as Iglidur® G, Iglidur® W300, Iglidur® J, Iglidur® X and Iglidur® M250. These polymer materials distinguish themselves through their good resistance against acid and alkane and exwellent vibration dampening, they do not need use of seal or oil scraper rings, so installment and replacement of these parts are quite easy.

In the embodiment as shown, the mobile rod is a hollow square rod 7. The mobile rod made of a hollow duct can be employed to install wires or pipetting catheters. For example, it can be employed for housing layout, including catheters connected with tubes for transferring and extracting liquid and wires for various elements and mechanisms, such as cords of the liquid level sensor and cords of the motors. A wiring duct connector 33 can be disposed at the top of the square rod 7.

The pipetting mechanism provided by the present invention further comprises a gear 16, which is mounted onto the mobile seat (e.g., either outer side or inner side of the frame) and can turn around the vertical direction (i.e. turn on the level plane). In the embodiment as shown, the gear is disposed outside and opposite the frame on which the mobile rod 7 is disposed. The gear can form a gear pair with a rack that is horizontally disposed, so as to drive the mobile seat to make horizontal movements along the rack at the time when the gear turns. A drive motor 12 drives the gear to turn. The gear drive motor 12 can be disposed above the gear; for example, it can be perpendicularly disposed onto a motor seat 11 that is fastened outside the frame of the mobile seat. The gear drive motor conveys motion to the gear 16 via a coupler 8. Preferably, the gear drive motor is a server motor.

The pipetting mechanism provided by the present invention further comprises a linear rail fastening seat 34, which is fastened onto the mobile seat and is provided for establishing fastening with a slider of the linear rail. In one aspect of the present invention, the linear rail fastening seat 34 is fastened outside the frame of the mobile seat (e.g., the right frame 24 as shown). The linear rail fastening seat has a square surface with a size same as or similar to that of the surface of the slider of the linear rail. In one aspect of the present invention, the height of the linear rail fastening seat H1 is not smaller than 25 mm, preferably not smaller than 30 mm. Linear rails that can fit with or be used in the pipetting mechanism or the full automatic pipetting instrument equipped with the pipetting mechanism provided by the present invention are linear rails with a slider width w (i.e. the length of a slider of a linear rail in the direction perpendicular to a sliding rack of the linear rail) not smaller than 25 mm, preferably not smaller than 30 mm. The use of a linear rail with aforementioned slider width and/or a linear rail fastening seat with aforesaid height unexpectedly improves stability to a great extent for operating the pipetting mechanism provided by the present invention. The linear rail fastening seat and the slider of the linear rail used in the pipetting mechanism provided by the present invention can be fastened by means of screws or the like, so that the mobile seat can slide along the linear rail. In the pipetting mechanism or the fully automatic pipetting instrument equipped with the pipetting mechanism provided by the present invention, the linear rail is horizontally disposed so that the mobile seat can make horizontal movements along the direction of the linear rail.

In one aspect of the present invention, the pipetting mechanism provided by the present invention is equipped with a linear rail fastener 35, and the linear rail fastening seat 34 can be connected with the mobile seat through it being fastened onto the mobile rail fastener 35. The linear rail fastener 35 and the mobile seat can be cast integrally; alternatively, the linear rail fastener 35 can be fastened onto the mobile seat through screws or the like. In another embodiment of the present invention, the linear rail fastener 35 can be part of the frame. In one aspect of the present invention, the height of the linear rail fastener is greater than or equal to twice of the height H2 of the linear rail fastening seat. Preferably, the height of the linear rail fastener is not smaller than 50 mm, preferably not smaller than 60 mm. the linear rail fastening seat 34 can be fastened either at the upper part or the lower part of the linear rail fastener 35.

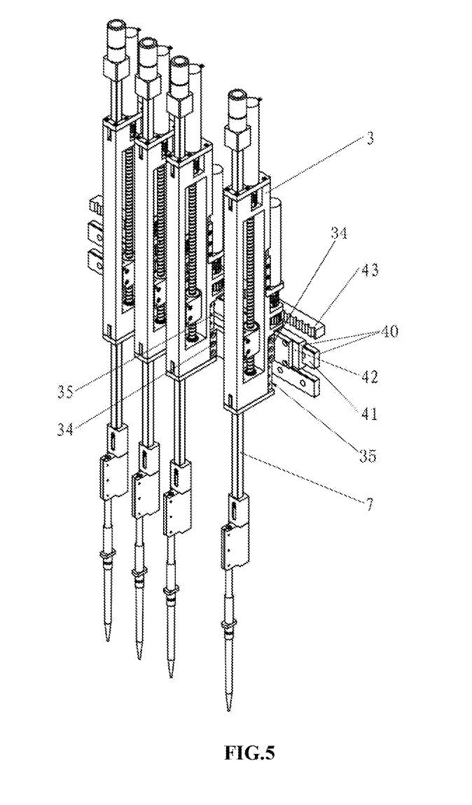

In the pipetting mechanism provided in the preferred embodiment of the present invention, for example, in the preferred embodiment as shown, the gear 16 capable of turning around a vertical axis and the linear rail fastening seat 34 is disposed at the same side outside one frame of the mobile seat, namely outside the right frame as shown. As shown in FIG. 1 or FIG. 5, the rack 43 pairing with the gear 16 is disposed parallel to the linear rail 40 connected with the linear rail fastening seat 34. The gear 15 and the linear rail fastening seat 34 are so positioned that the mobile seat, which is fastened with the slider of the linear rail, is driven to make horizontal movements along the direction of the rack and the sliding track of the linear rail when the gear 16 turns. Preferably, the gear 16 and the linear rail fastening seat 34 are disposed on the same side of the frame, while the corresponding rack 43 and the linear rail 40 are arranged parallel with one situating above the other. Accordingly, such a design allows saving significant inner space of an automatic pipetting instrument using the pipetting mechanism provided by the present invention. In other embodiments, the gear 16 and the linear rail fastening seat 34 can alternatively be disposed at any other position as appropriate on the mobile seat that enables to drive the mobile seat, which is fastened with the slider of the linear rail, to make horizontal movements along the direction of the rack and the sliding track of the linear rail.

The pipetting mechanism provided in a preferred embodiment of the present invention further comprises a pipette mounted at the lower end of the mobile rod 7. The pipette is a mechanism for performing functions of detecting and drawing in liquid and comprises elements for performing the abovementioned functions. In an embodiment as shown, the pipette comprises a pipetting holder 27, a detachable sleeve 28, a catheter 26, a stopper 31, a pipetting tip 30 and a liquid level sensor 25. Wherein, the pipetting holder 27 is provided for mounting the liquid level sensor 25 and the catheter 26, while the catheter is provided for joining the pipetting tip 30 and the stopper 31. The detachable sleeve 28 allows separation of the pipetting tip from the catheter so as to realize the purpose of automatic replacement. Because the pipetting tip is tightly connected with the catheter, so the detachable sleeve needs to allow separating the pipetting tip from the catheter within a very small range of distance. However, the design of the pipetting tip of the pipetting mechanism provided by the present invention allows the detachable sleeve to fulfill such a purpose. The liquid level sensor can be employed to detect the distance between liquid contained in a standard liquid container (e.g., a 8-well plate or a 96-well plate), which is placed under the pipetting tip, and the pipetting tip, and to feed signals to the automatic work station and, when it is necessary, to feed signals to an instrument operating the pipetting mechanism under control of a program.

The fully automatic pipetting work station provided by the present invention can be equipped with four or eight pipetting mechanisms as described above. The four or eight pipetting mechanisms can either individually make horizontal or longitudinal (vertical) movements, or concurrently make horizontal or longitudinal (vertical) movements. Besides, the two neighboring pipetting mechanisms experience the same change to horizontal translation, which allows the neighboring pipetting tips to experience the same change to horizontal translation.

FIG. 5 shows a 3D view from another angle of part of the pipetting work station provided in a preferred embodiment of the present invention.

The fully automatic pipetting work station provided by the present invention is normally equipped with four or eight pipetting mechanism. The eight pipetting mechanisms are arranged in two parallel groups, wherein four pipetting mechanisms in each group are installed side by side. The mobile rods of the four pipetting mechanisms in each group lay out on the same line; the linear rail fastening seats 34 on the mobile seats of two neighboring pipetting mechanism are discretely fastened on either the upper part or the lower part of the linear rail fasteners 35, so that the mobile seats of two among the four pipetting mechanisms in each group can discretely be connected with the two sliders of the same linear rail (through the linear rail fastening seat and the liner rail stoppers). Such a design allows saving significant inner space of an automatic pipetting instrument using the pipetting mechanism provided by the present invention. In the pipetting work station provided by the present invention, the mobile rods of the four pipetting mechanisms in each group lay out on the same line and are arranged in a staggered manner with the mobile rods of the four pipetting mechanisms in the other group, so that the pipetting tips of the eight pipetting mechanisms can lay out on the same line.

A multichannel pipetting apparatus fabricated with 8 pipetting mechanisms as described above can easily cope with standard liquid containers such as 8-well plates, 24-well plates and 96-well plates. Each pipetting mechanism in the apparatus can independently make upward and downward movements.

The pipetting work station provided by the present invention can be applied in such operations as sensing, detecting, drawing and ejecting liquid, thereby allows liquid transferring operations.

The present invention further provides use of the pipetting mechanism, the multichannel pipetting apparatus or the fully automatic pipetting work station for sensing, detecting, suctioning and ejecting liquid thereby allowing liquid transfer.

In practice, the entire operation procedure of the pipetting work station provided in the preferred embodiment of the present invention is as follows:

where a liquid contained in a standard liquid container (e.g., a 8-well plate or a 96-well plate) needs to be drawn in or ejected, the pipetting mechanism is moved to stay above the standard liquid container. The liquid level sensor detects the distance between the pipetting tip and the liquid in the standard liquid container under the pipette, and feed signals to the controlling system. The lead screw can be driven to turn by the mobile rod drive motor 13; by means of a drive connector 17, the lead screw enables the mobile rod 7 to make longitudinally up and down movements within a longitudinal hole on the left frame of the mobile seat, and this accordingly enables the pipette to make upward and downward movements. When it is necessary for the mobile seat to make movements in the horizontal direction, the gear drive motor 12 drives the gear to turn on the horizontal plane, and this accordingly drives the mobile seat to make horizontal movements along the linear rail through establishing connection with the slider of the linear rail.

The design of the pipetting mechanism provided by the present invention allows each of the pipetting mechanism equipped in the pipetting work station to fully independently make longitudinal or horizontal movements, as there is no connection between the pipetting mechanisms. The overall structural layout is more reasonable, and the space for accommodating movement becomes much clearer, while difficulty and complexity suffered in adjustment job during the process of assembly are greatly reduced. When it comes to maintenance of the pipetting mechanism, it only requires fixing or replacing a damaged pipetting channel, while other channels are left intact.

As parts in the mechanism for controlling movements of the pipette in the pipetting work station provided by the present invention are made of a self-lubricating maintenance-free polymer material, this makes it unnecessary to lubricate the parts or reduces lubricating service to the parts, which accordingly avoid the potential of contamination arising from oil lubricant to the pipetting operation.

Although the exemplary embodiments and their advantages have been described at length herein, it should be understood that various alternations, substitutions and modifications may be made to the embodiments without departing from the spirit of the present invention and the scope as defined by the appended claims. As for other examples, it may be easily appreciated by a person of ordinary skill in the art that the order of the process steps may be changed without departing from the scope of the present invention.

In addition, the scope, to which the present invention is applied, is not limited to the process, mechanism, manufacture, material composition, means, methods and steps described in the specific embodiments in the specification. According to the disclosure of the present invention, a person of ordinary skill in the art should readily appreciate from the disclosure of the present invention that the process, mechanism, manufacture, material composition, means, methods and steps currently existing or to be developed in future, which perform substantially the same functions or achieve substantially the same as that in the corresponding embodiments described in the present invention, may be applied according to the present invention. Therefore, it is intended that the scope of the appended claims of the present invention includes these process, mechanism, manufacture, material composition, means, methods or steps.

1. A pipetting work station comprising:
(a) a pipetting mechanism bracket;
(b) a plurality of pipetting mechanisms, wherein the pipetting mechanism comprises:
a mobile seat (1);
a mobile rod (7) movably mounted onto the mobile seat (1), wherein the mobile rod can make movements along the vertical direction against the mobile seat;
a mobile rod drive mechanism comprising a lead screw (4) and a drive mechanism for the lead screw that are disposed parallel to the mobile rod (7), wherein the lead screw (4) is securely connected with the mobile rod (7) via a drive connector (17);
a gear (16) and a drive mechanism for the gear that are mounted onto the mobile seat (1), wherein the gear (16) can turn around the vertical direction;
a linear rail fastening seat (34) fastened onto the mobile seat (1); and
a pipette body disposed at the lower end of the mobile rod (7);
(c) a horizontally disposed rack (43) that forms a gear pair with the gear (16) of the pipetting mechanism, which drives the mobile seat to make horizontal movements along the rack when the gear turns; and
(d) a horizontally disposed linear rail that is parallel to the rack; a slider of the linear rail is connected and fastened with the linear rail fastening seat (34) of the pipetting mechanism, so that the mobile seat can make horizontal movements along a track of the linear rail with the slider of the linear rail.

2. The pipetting work station of claim 1, wherein the mobile seat has a quadrangular frame, and the mobile rod (7) is movably mounted at one side of the frame of the mobile seat (1).

3. The pipetting mechanism of claim 2, wherein the frame for accommodating the mobile rod (7) has a groove, which opens inward to the mobile seat; the mobile rod is movably mounted in the groove, whilst part of the mobile rod sticks out beyond the groove, namely, protrudes beyond the inner surface of the left frame; the protruding part of the mobile rod can be employed to establish a secure connection with the drive connector (17) of the drive mechanism for the mobile rod.

4. The pipetting work station of claim 3, wherein the mobile rod is mounted in the frame of the mobile seat via a mobile rod sleeve disposed on the frame, wherein the mobile rod sleeve is securely connected with the frame, and the mobile rod can move in the mobile rod sleeve.

5. The pipetting work station of claim 4, wherein the mobile rod sleeve is a sleeve made of a polymer material.

6. The pipetting work station of claim 1, wherein the drive mechanism for the lead screw comprises a drive motor for the lead screw wherein the drive motor is a server motor.

7. (canceled)

8. The pipetting work station of claim 1, wherein the lead screw (4) is securely connected with the mobile rod (7) via a nut (6) and the drive connector (17); wherein the nut is threaded onto the lead screw; one end of the drive connector (17) is securely connected with the mobile rod (7), while the other end of the drive connector (17) is fastened at the outer side of the nut (6).

9. The pipetting work station of claim 1, wherein the linear rail fastening seat (34) is connected with the mobile seat via a linear rail fastener (35).

10. The pipetting work station of claim 1, wherein the height of the linear rail fastening seat (34) H1 is greater than or equal to 30 mm.

11. The pipetting work station of claim 9, wherein the height of the linear rail fastener H2 is greater than or equal to 60 mm.

12. The pipetting work station of claim 1, wherein the pipette body comprises a stopper, a pipetting holder (25), a catheter connected below the pipetting holder, wherein the catheter can be connected with a replaceable pipetting tip.

13. The pipetting work station of claim 1, wherein two or more of the plurality of pipetting mechanisms are installed side by side; the two or more of the plurality of pipetting mechanisms, which are installed side by side, lay out on the same line, and the gears of the two or more of the plurality of pipetting mechanisms that are installed side by side pair with the same piece of rack to form gear pairs.

14. The pipetting work station of claim 13, wherein the mobile seats of two neighboring pipetting mechanisms among the two or more pipetting mechanisms that are installed side by side are connected with the two sliders of the same linear rail.

15. The pipetting work station of claim 13, wherein the linear rail fastening seats (34) on the mobile seats of two neighboring pipetting mechanisms among the two or more pipetting mechanisms that are installed side by side are discretely fastened onto either the upper part or the lower part of their own linear rail fasteners.

16. The pipetting work station of claim 1 comprising eight of the pipetting mechanisms; the eight pipetting mechanisms are arranged in two parallel groups; four pipetting mechanisms in each group are installed side by side; the gears of the four pipetting mechanisms in each group form gear pairs with the same rack; and the linear rail fastening seats of the mobile seats of every two pipetting mechanisms among the four pipetting mechanisms in each group are connected with the two sliders of the same linear rail.

17. The pipetting work station of claim 16, the linear rail fastening seats (34) on the mobile seats of two neighboring pipetting mechanisms are discretely fastened onto either the upper part or the lower part of the linear rail fasteners (35).

18. The pipetting work station of claim 16, wherein the mobile rods of the four pipetting mechanisms in each group lay out on the same line and are arranged in a staggered manner with the mobile rods of the four pipetting mechanisms in the other group, so that the pipetting tips of the eight pipetting mechanisms can lay out on the same line.

19. A pipetting mechanism having a structure as described in claim 1, wherein the pipetting mechanism comprises:
a mobile seat (1);
a mobile rod (7) movably mounted onto the mobile seat (1), wherein the mobile rod can make movements along the vertical direction against the mobile seat;
a mobile rod drive mechanism comprising a lead screw (4) and a drive mechanism for the lead screw that are disposed parallel to the mobile rod (7), wherein the lead screw (4) is securely connected with the mobile rod (7) via a drive connector (17);
a gear (16) and a drive mechanism for the gear mounted onto the mobile seat (1), wherein the gear (16) can turn around the vertical direction;
a linear rail fastening seat (34) fastened onto the mobile seat (1); and
a pipette body disposed at the lower end of the mobile rod (7).

20. The pipetting mechanism of claim 19 characterized in that the mobile seat has a quadrangular frame, and the mobile rod (7) is movably mounted at one side frame of the mobile seat (1); the frame for accommodating the mobile rod (7) has a groove, which opens inward to the mobile seat; the mobile rod is movably mounted in the groove, whilst part of the mobile rod sticks out beyond the groove, namely, protrudes beyond the inner surface of the left frame; the protruding part of the mobile rod can be employed to establish a secure connection with the drive connector (17) of the drive mechanism for the mobile rod;
wherein the drive mechanism for the lead screw comprises a drive motor for the lead screw, wherein the lead screw is securely connected with the mobile rod (7) via a nut (6) and the drive connector (17); wherein, the nut is threaded onto the lead screw; one end of the drive connector (17) is securely connected with the mobile, while the other end thereof is fastened at the outer side of the nut (6);
wherein the linear rail fastening seat (34) is connected with the mobile seat via the linear rail fastener (35); the height of the linear rail fastening seat (34) H1 is greater than 30 mm, and the height of the linear rail fastener (35) H2 is greater than or equal to 60 mm.

21. The pipetting mechanism of claim 19 characterized in further comprising a horizontally disposed rack that pairs with gear to form a gear pair, the mobile seat is driven to make horizontal movements along the rack when the gear turns, and a linear rail that is horizontally disposed and is parallel to the rack; a slider of the linear rail is connected and fastening with the linear rail fastening seat (34), thereby the mobile seat can make horizontal movements along the track of the linear rail with the slider of the linear rail; wherein the gear (16) and the linear rail fastening seat (34) are so positioned so that, when the gear turns, the mobile seat is driven to make movements along the sliding track of the linear rail.
